(19) United States
(12) Patent Application Publication
(10) Pub. No.: US 2026/0145756 A1
(43) Pub. Date: May 28, 2026

(54) ROAD RACING BICYCLE FRAME

(71) Applicant: F.I.V. Fabbrica Italiana Velocipedi Edoardo Bianchi S.p.A., Treviglio (IT)

(72) Inventor: Marco Borgonovo, Treviglio (IT)

(21) Appl. No.: 19/121,721

(22) PCT Filed: Oct. 17, 2022
(86) PCT No.: PCT/IT2022/000053

§ 371 Date: Apr. 16, 2025

(51) Int. Cl. B62J 17/00; B62K 3/04; B62K 19/32; B62K 21/02

(52) U.S. Cl. CPC B62J 17/00; B62K 3/04; B62K 21/02; B62K 19/32

(57) ABSTRACT

The present invention relates to a road racing bike frame (10), comprising: a top tube (12); a down tube (14); a head element (16) connected to or merging with the top tube and the down tube; optionally a front fork (18); a first winglet (20a) arranged on a left outer side of the road racing bike frame; and a second winglet (20b) arranged on a right outer side of the road racing bike frame.

### TECHNICAL FIELD

The present invention relates to a road racing bike frame. The present invention also relates to a road racing bike comprising such a frame.

### BACKGROUND

Road racing bikes, also referred to as (road) racing bicycles, may travel at average speeds as high as about 40-55 km/h, with top speeds as high as about 80-90 km/h. It is therefore a wish that road racing bikes have good aerodynamics.

### SUMMARY OF THE INVENTION

It is an object of the present invention to provide an improved road racing bike frame, which in particular has improved aerodynamics.

These and other objects are achieved by the present invention as defined in the appended independent claim(s). Embodiments are set forth in the appended dependent claims.

### BRIEF DESCRIPTION OF THE DRAWINGS

The present invention will now be described in more detail, with reference to the appended drawings showing currently preferred embodiments of the invention.

FIG. 1 is a partial side view of a road racing bike frame with winglets according to one or more embodiments of the present invention.

FIG. 2 is partial front view of the road racing bike frame of FIG. 1.

FIG. 3 is side view illustrating e.g. exemplary size of the winglets.

FIG. 4 is a partial side view of the road racing bike frame of FIG. 1 without the winglets.

FIG. 5 is partial front view of the road racing bike frame of FIG. 1 without the winglets.

FIG. 6 illustrates an airfoil of the winglet.

FIG. 7 illustrates top views of the headtube with and without winglets as well as air pressure.

FIG. 8 is a top view illustrating wakes with the winglets.

FIG. 9 is a top view illustrating wakes without the winglets.

FIG. 10 illustrate a road racing bike frame with winglets according to another embodiment of the present invention.

FIG. 11 is a side view of a road racing bike according to an aspect of the present invention.

### DETAILED DESCRIPTION OF THE INVENTION

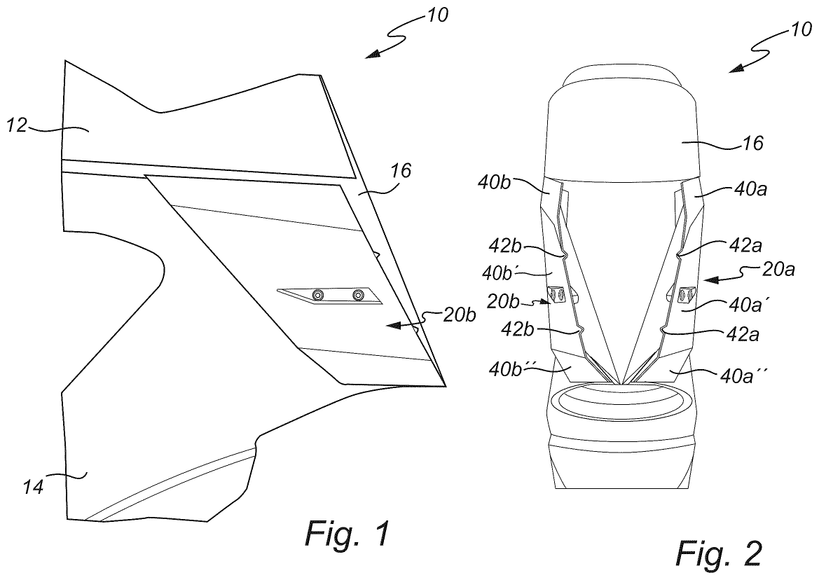

FIGS. 1-2 illustrate a road racing bike frame 10 according to one or more embodiments of the present invention. The road racing bike frame 10 could also be referred to as (road) racing bicycle frame 10. It should be noted that the present frame 10 also could be used on the track or for time trial.

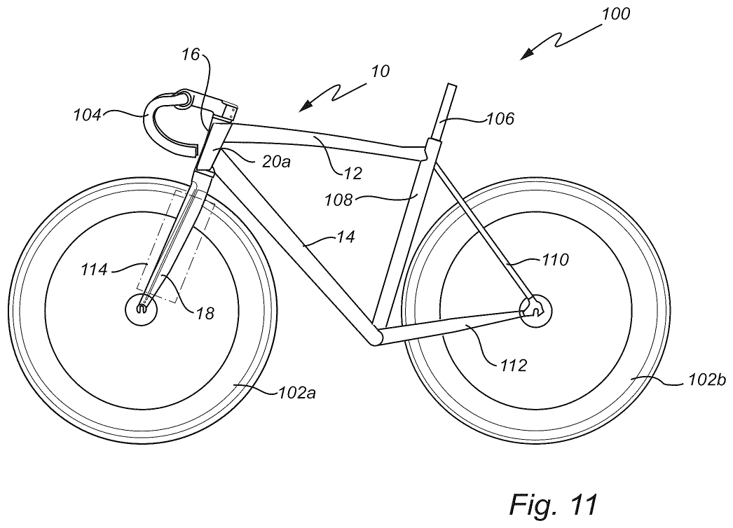

The road racing bike frame 10 may comprise a top tube 12, a down tube 14, and a head element 16 connected to or merging with the top tube 12 and the down tube 14. The head element 16 may for example be a head tube. The road racing bike frame 10 may also comprise a front fork 18 (see FIG. 11), with left and right fork blades.

According to the present invention, the road racing bike frame 10 further comprises a first (left) winglet 20a arranged on a left outer side (as seen in/relative to the forward riding direction 34) of the road racing bike frame 10, and a corresponding a second (right) winglet 20b arranged on a right outer side of the road racing bike frame 10. The first and second winglets 20a-b could also be referred to as air deflectors. The first and second winglets 20a-b improve the aerodynamics of the road racing bike frame 10, which will be discussed/explained further hereinbelow.

In FIGS. 1-2, the first winglet 20a is arranged on a left outer side (surface) 22a of the head element 16, and the second winglet 20b is arranged on a right outer side (surface) 22b of the head element 16. With this position of the winglets 20a-b, they do not enter in interference with the bike or rider while being used, while they do improve the aerodynamics of the road racing bike frame 10. Being arranged at the head element 16 (or on the front fork 18 as indicated in FIG. 11), the winglets 20a-b could be referred to as front winglets 20a-b.

The winglets 20a-b may for example be made of polymer or metal/alloy or composites material.

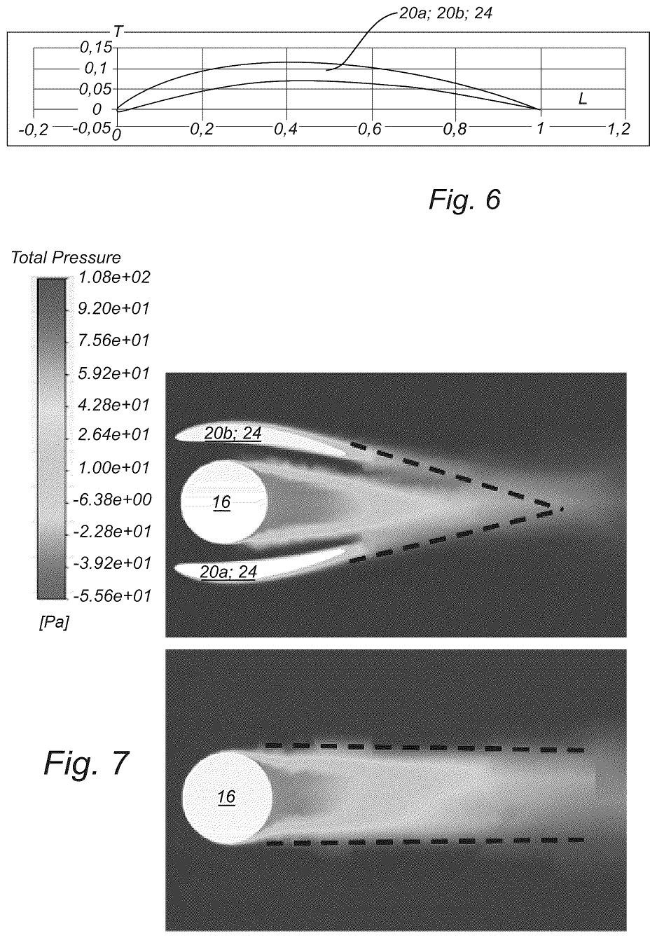

With further reference to FIG. 6, each of the first winglet 20a and the second winglet 20b preferably has the shape of an airfoil 24. This shape may improve the airflow around the head element 16. An airfoil (or aerofoil) like airfoil 24 may generally be defined as a body designed to provide a desired reaction force when in motion relative to the surrounding air. The first and second winglets 20a-b in general, and the airfoils 24 in particular, may be substantially vertically arranged. The latter can be seen in the top view of FIG. 7. That is, the cross section of the winglets 20a-b as seen from above may be airfoil-shaped. The airfoil 24 may have a camber value between 0 and 10%, a maximum camber position between 0 and 90%, and a thickness T between 1 and 40% of the chord length L of the airfoil 24. Furthermore, concave sides of the airfoils 24 may face the head element 16 (whereas convex sides of the airfoils 24 are facing away from the head element 16), as also seen in the top view of FIG. 7.

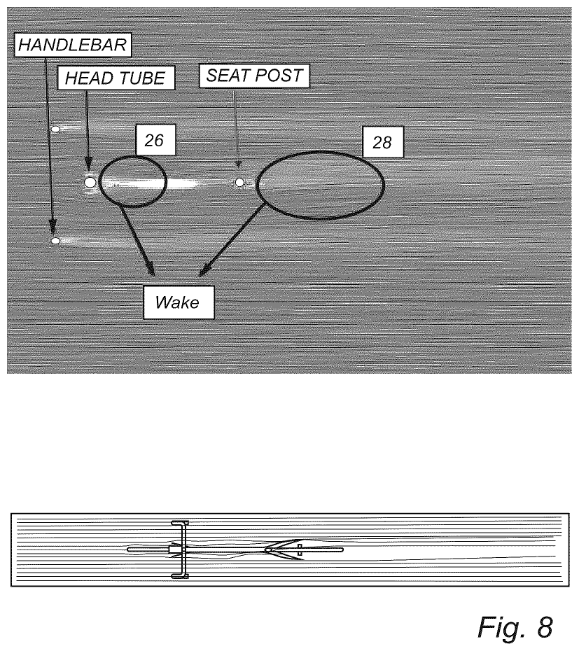

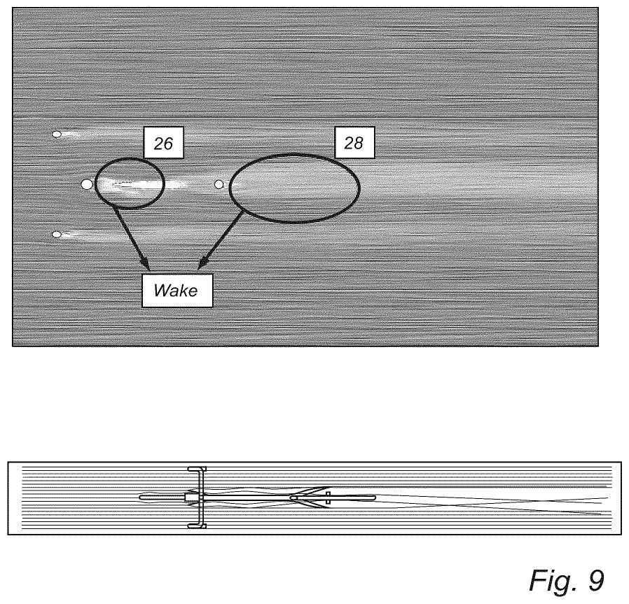

The aerodynamic improvement by means of the winglets 20a-b/airfoil 24 has been proved by CFD (Computational Fluid Dynamics) analysis. The CFD analysis shows how the winglets 20a-b reduce the turbulent area behind the head element 16 obtaining a smaller drag force (i.e. wind resistance). FIG. 7 shows a section in the middle of the head element/tube 16, with the winglets 20a-b (top) and without winglets (bottom). With the winglets 20a-b, one can see in FIG. 7 that the turbulent area behind the head element 16 is smaller than without the winglets. Furthermore in FIGS. 8-9, it can be seen that the wake 26 behind the head tube 16 is smaller when there are winglets 20a-b (FIG. 8) compared to without the winglets (FIG. 9). Also the wake 28 behind the seat post is bigger when there are no winglets. The overall results of the CFD analysis are presented in Table 1:

TABLE 1

| MODEL | Cd | A [m\hat{ }2] | CdA [m\hat{ }2] | Fd [N] | Power [W] |
|---|---|---|---|---|---|
| With winglets | 0.625 | 0.076 | 0.0475 | 4.56 | 57.0 |
| Without winglets | 0.642 | 0.075 | 0.0481 | 4.61 | 57.7 |

Cd = Coefficient of Drag, A = Frontal Area exposed to wind flow, CdA = Normalized Coefficient of Drag (=coefficient of drag multiplied by frontal area), Fd = Drag force, and Power = Drag Power. The test result are at 45 km/h bike speed.

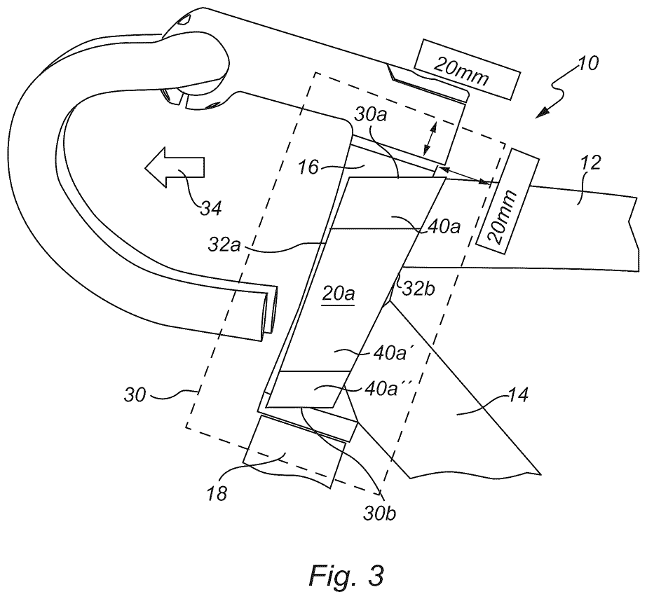

Turning to FIG. 3, wherein each of the first winglet 20a and the second winglet 20b may have a size substantially corresponding to the head element 16 as seen from the side. Specifically, the height and the width of each winglet 20a-b could be within the two dimensions of a box 30 which overlaps the height and the width of the head tube 16 of about 20 mm. As also seen in FIG. 3 (as well as in FIG. 1), each of the first and second winglets 20a-b may have the shape of a trapezium as seen from the side of the road racing bike frame 10, which trapezium has substantially parallel top and bottom sides 30a-b, a front side 32a leaning backwards relative to the forward riding direction 34 of the road racing bike frame, and a rear side 32b leaning more backwards than the front side 32a.

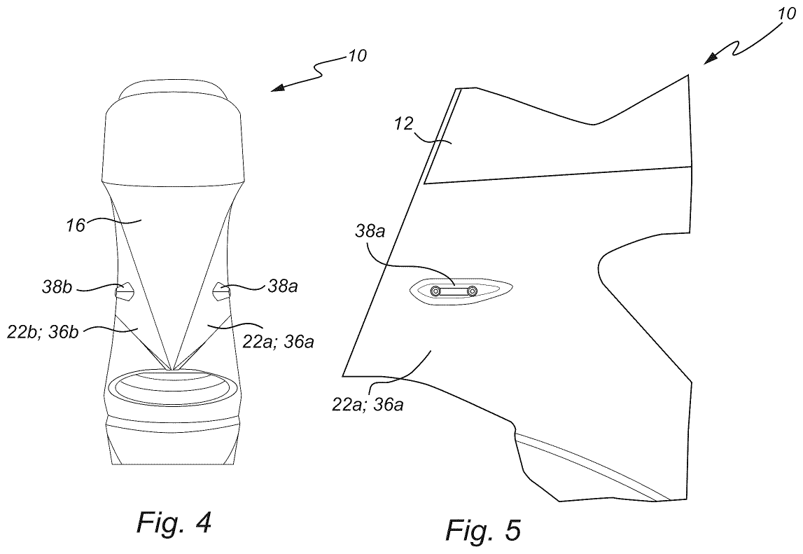

Furthermore, wherein the first winglet 20a may be arranged at a first recessed portion 36a on the left outer side 22a of the head element 16, and the second winglet 20b may be arranged at a second recessed portion 36b on the right outer side 22a of the head element, see further FIGS. 4-5. By this, it is further assured that the winglets 20a-b do not enter in interference with the bike or rider while being used. Furthermore, the recessed portions 36a-b may decrease the frontal area (of the head element 16) exposed to wind flow. With same coefficient of drag, the normalized coefficient will be lower and drag is reduced. The depth of the first and second recessed portions 36a-b may increase in the forward direction of the road racing bike frame 10, and the depth at the front of the first and second recessed portions 36a-b may as well increase in a downward direction of the road racing bike frame 10, as appreciated in particular from FIG. 4.

Furthermore, the first recessed portion 36a may comprise a first protrusion 38a to which the first winglet 20a is mounted, wherein the second recessed portion 36b comprises a second protrusion 38b to which the second winglet 20b is mounted. The winglets 20a-b are preferably attached/mounted by standard lateral screws, but the utilization of snap fit, magnets, or adhesives is also feasible. To this end, the road racing bike frame 10 may have threaded inserts dedicated for the winglets 20a-b, in particular on the protrusions 38a-b. Preferably the first and second protrusions 38a-b are elongated in the forward/rearward direction of the road racing bike frame, to be aerodynamically efficient.

Furthermore, the first winglet 20a may have has a first inwardly angled upper portion 40a, an intermediate portion 40a′, and a first inwardly angled lower portion 40a″. Correspondingly, the second winglet 20 may have a second inwardly angled upper portion 40b, an intermediate portion 40b′, and a second inwardly angled lower portion 40b″. Specifically, the inwardly angled portions may (each) be angled in relation to the respective intermediate portion e.g. by 10-30 degrees, be angled inwards towards the head element 16 (or the respective fork blade), extend along the complete width of the winglets 20a-b, and/or have a height corresponding to 10-25% of the total height of each winglet 20a-b. By the inwardly angled portions, any vortexes at the top and bottom tips of the winglets 20a-b, which vortexes may create unwanted drag, are reduced or eliminated. Preferably the first winglet 20a is mounted to the first protrusion 38a at the intermediate portion 40a′, and the second winglet 20a is mounted to the second protrusion 38b at the intermediate portion 40b′.

Furthermore, (the intermediate portion 40a′ of) the first winglet 20a could have a first inwards ridge 42a on each side of the first protrusion 38a as seen in the upward/downward direction of the road racing bike frame 10, which first inwards ridges 42a are elongated in the forward/rearward direction of the road racing bike frame 10. Likewise, (the intermediate portion 40b′ of) the second winglet 20b could have an elongated second inwards ridge 42b on each side of the second protrusion 38a. The inwards ridges 42a-b serve to keep the air flow straight, and to avoid having a rotating flow at the trailing edge 32b of each winglet 20a-b which would generate a bigger wake.

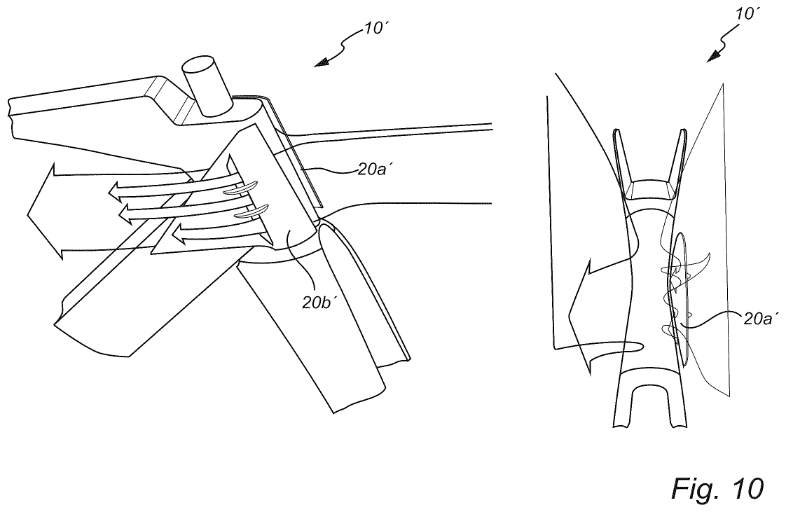

FIG. 10 illustrates a road racing bike frame 10′ with winglets 20a′ and 20b′ according to another embodiment of the present invention. Here the winglets 20a′ and 20b′ have a triangular shape as seen from the side, which triangular shape points (generally) backwards in relation to the forward riding direction.

Finally FIG. 11 illustrates a road racing bike 100 according to an aspect of the present invention. The road racing bike 100 could also be referred to as (road) racing bicycle 100. It should be noted that the bike/bicycle 100 also can be used on the track or for time trial.

The road racing bike 100 comprising the present road racing bike frame 10 (or 10′) with the winglets 20a-b (or 20a′ and 20b′). The road racing bike 100 may further comprise-among other things-two wheels 102a-b in tandem, the front fork 18, handlebars 104 for steering, a seat post 106, a saddle (not shown), and pedals (not shown) for propelling the road racing bike. The road racing bike 100 will typically not be electrically assisted. The road racing bike frame 10 may further comprise a seat tube 108, seat stays 110, and chain stays 112.

As discussed above, the winglets 20a-b may be arranged one on each side of the head tube 16. Alternatively or in addition, the first winglet may be arranged on a left outer side of the left fork blade of the front fork 18, wherein the second winglet is arranged on a right outer side of the right fork blade of the front fork 18, as indicated by 114 in FIG. 11. Here, each winglet may have a similar dimension to the side view of the fork blade.

The person skilled in the art realizes that the present invention by no means is limited to the embodiments described above. On the contrary, many modifications and variations are possible within the scope of the appended claims.

1. A road racing bike frame (10), comprising:
a top tube (12);
a down tube (14);
a head element (16) connected to or merging with the top tube and the down tube;
optionally a front fork (18);
a first winglet (20a) arranged on a left outer side of the road racing bike frame; and
a second winglet (20b) arranged on a right outer side of the road racing bike frame.

2. A road racing bike frame according to claim 1, wherein the first winglet is arranged on a left outer side of the head element of the road racing bike frame, and wherein the second winglet is arranged on a right outer side of the head element of the road racing bike frame.

3. A road racing bike frame according to claim 1, comprising the front fork having a left fork blade and a right fork blade, wherein the first winglet is arranged on a left outer side of the left fork blade of the front fork of the road racing bike frame, and wherein the second winglet is arranged on a right outer side of the right fork blade of the front fork of the road racing bike frame.

4. A road racing bike frame according to any one of the claims, wherein each of the first winglet and the second winglet has the shape of an airfoil.

5. A road racing bike frame according to claim 4, wherein the airfoil is substantially vertically arranged.

6. A road racing bike frame according to claim 4 or 5, wherein the airfoil has at least one of:
a camber value between 0 and 10%;
a maximum camber position between 0 and 90%, and
a thickness between 1 and 40% of the chord length of the airfoil.

7. A road racing bike frame according to claim 2, wherein the first winglet and the second winglet are configured to reduce a turbulent area behind the head element.

8. A road racing bike frame according to claim 2, wherein each of the first winglet and the second winglet has a size substantially corresponding to the head element as seen from the side.

9. A road racing bike frame according to claim 2, wherein the first winglet is arranged at a first recessed portion on the left outer side of the head element, and wherein the second winglet is arranged at a second recessed portion on the right outer side of the head element.

10. A road racing bike frame according to claim 9, wherein the first recessed portion comprises a first protrusion to which the first winglet is mounted, and wherein the second recessed portion comprises a second protrusion to which the second winglet is mounted.

11. A road racing bike frame according to any one of the preceding claims, wherein the first winglet has a first inwardly angled upper portion, an intermediate portion, and a first inwardly angled lower portion, and wherein the second winglet has a second inwardly angled upper portion, an intermediate portion, and a second inwardly angled lower portion.

12. A road racing bike frame according to any one of the preceding claims, wherein each of the first and second winglets has the shape of a trapezium as seen from the side of the road racing bike frame, which trapezium has substantially parallel top and bottom sides, a front side leaning backwards relative to the forward riding direction of the road racing bike frame, and a rear side leaning more backwards than the front side.

13. A road racing bike frame according to any one of the preceding claims, wherein the head element is a head tube.

14. A road racing bike (100) comprising a road racing bike frame (10) according to any one of the preceding claims.

15. A road racing bike according to claim 14, further comprising two wheels in tandem, the front fork, handlebars for steering, a saddle, and pedals for propelling the road racing bike.
